(19) United States
(12) Patent Application Publication
(10) Pub. No.: US 2023/0297910 A1
(43) Pub. Date: Sep. 21, 2023

(54) SYSTEMS AND METHODS FOR CONTROLLING A PROJECT

(71) Applicant: Tameika Givens, Stone Mountain, GA (US)

(72) Inventor: Tameika Givens, Stone Mountain, GA (US)

(21) Appl. No.: 18/122,405

(22) Filed: Mar. 16, 2023

Related U.S. Application Data
(60) Provisional application No. 63/320,429, filed on Mar. 16, 2022.

(51) Int. Cl. G06Q 10/0631

(52) U.S. Cl. CPC G06Q 10/06313

(57) ABSTRACT

Systems and methods for controlling projects are disclosed herein. An example system includes a processor and a memory operably coupled to the processor. The system is configured to register a plurality of users; receive user information from at least one of the plurality of users; receive project information from at least one of the plurality of users, where the project information represents a project, and where the project information includes information representing a plurality of jobs associated with the project information; assign a job from the plurality of jobs to one of the plurality of users; determine a state of the job; and initiate an exchange based on the project information and user information. In some implementations, the system can receive project information or user information from external sources. Additionally, in some implementations, the system can transmit project information and/or user information to one or more users.

### CROSS-REFERENCE TO RELATED APPLICATION

This application claims priority to, and the benefit of, Provisional Patent Application No. 63/320,429 filed Mar. 16, 2022, the entire contents of which is hereby incorporated by reference.

### BACKGROUND

Project management can involve tracking, processing, storing, and transmitting information between different individuals and entities. Each of these steps can require the use of different systems, and the result is that multiple different systems can be required to track, process, store, and transmit information associated with a project.

To overcome the above, systems and methods that incorporate user information, project information, and/or location information would be advantageous. The presently disclosed systems and methods are directed at overcoming one or more of the issues set forth above, and/or other problems in the art.

### SUMMARY

According to one aspect, the present disclosure is direct to a system including a processor and a memory operably coupled to the processor. The memory has computer-executable instructions stored thereon that, when executed by the processor, cause the processor to: register a plurality of users; receive user information from at least one of the plurality of users; receive project information from at least one of the plurality of users, wherein the project information represents a project, and wherein the project information includes information representing a plurality of jobs associated with the project information; assign a job from the plurality of jobs to one of the plurality of users determine a state of the job; and initiate an exchange based on the project information and user information.

In some implementations, the user information includes location information.

In some implementations, the user information includes location information, and determining whether the job is completed is based at least partially on the location information.

In some implementations, determining the state of the job includes determining that the job is completed.

According to another aspect, the present disclosure is directed to a system including a plurality of client devices, each client device being associated with a respective user of a plurality of users and a server computing device. The server computing device is operably coupled to the client device via a network, wherein the server computing device comprises a processor and a memory operably coupled to the processor, where the memory has computer-executable instructions stored thereon that, when executed by the processor, cause the server computing device to: receive user information from at least one of the plurality of client devices; receive project information from at least one of the plurality of client devices, wherein the project information represents a project, and wherein the project information includes information representing a plurality of jobs associated with the project information; assign a job from the plurality of jobs to one of the plurality of users determine a state of the job; and complete an exchange based on the project information and the user information.

In some implementations, the user information includes location information.

In some implementations, the user information includes location information, and determining whether the job is completed is based at least partially on the location information.

In some implementations, determining the state of the job includes determining that the job is completed.

According to another aspect, the present disclosure is directed to a computer implemented method. In one implementation, the computer implemented method includes registering a plurality of users; receiving user information from at least one of the plurality of users; receiving project information from at least one of the plurality of users; assigning one or more jobs to one or more of the plurality of users based on the user information and project information; determining a state of the job; and completing an exchange based on the user information and the project information.

In some implementations, the user information includes location information.

In some implementations, the user information includes location information, and determining whether the job is completed is based at least partially on the location information.

In some implementations, determining the state of the job includes determining that the job is completed.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a flow chart of an example set of operations according to an implementation described herein.

FIG. 2 illustrates an example computing device upon which the methods described herein may be implemented.

FIG. 3 illustrates an example system for project management, according to an implementation described herein.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described in the context of transmitting and processing information related to building construction, it will become evident to those skilled in the art that the implementations are not limited thereto, but are applicable for other systems and methods for exchanging and processing information.

It should be understood that, throughout the present disclosure, the term “job” can refer to one or more activities, tasks, or sets of instructions. Similarly, it should also be understood that assigning a “job” to one or more users can include, as non-limiting examples: providing those users with sets of instructions, or providing those users with one or more tasks or activities to complete. Similarly, it should be understood that determining that a “job” is complete can include determining that the user has completed one or more tasks, activities, or instructions.

Project planning and management involves processing, storing, and disseminating large amounts of information. This information can describe the project that is being completed, as well as information about the workers and businesses that are associated with the project. In a large project, such as constructing a building, several organizations can be involved, as well as hundreds or thousands of workers. As a result, information about the project can be stored by countless individuals in numerous locations. This can make it more difficult for project planners or managers to administer a project, since the relevant information about the project can be spread out and not readily accessible. And, since the information can be in different applications on different devices, there can also be problems associated with collecting and organizing that information. These and other difficulties can translate into increased costs and lower efficiency.

It should be understood that the term “project management” is used throughout the present disclosure to refer to the administration or organization of any project. As described herein, the term “project” can refer to any set of one or more jobs, activities, tasks, or instructions. As described in the present disclosure, the terms “project management” and “project” can include simple projects, which can include as few as one job, task, activity, or instruction, as well as complex projects, which can include many jobs/tasks/activities/instructions.

Implementations of the present disclosure include a multi-layer, multi-channel, multi-tiered and multi-user platform that can be implemented using one or more client and/or server devices.

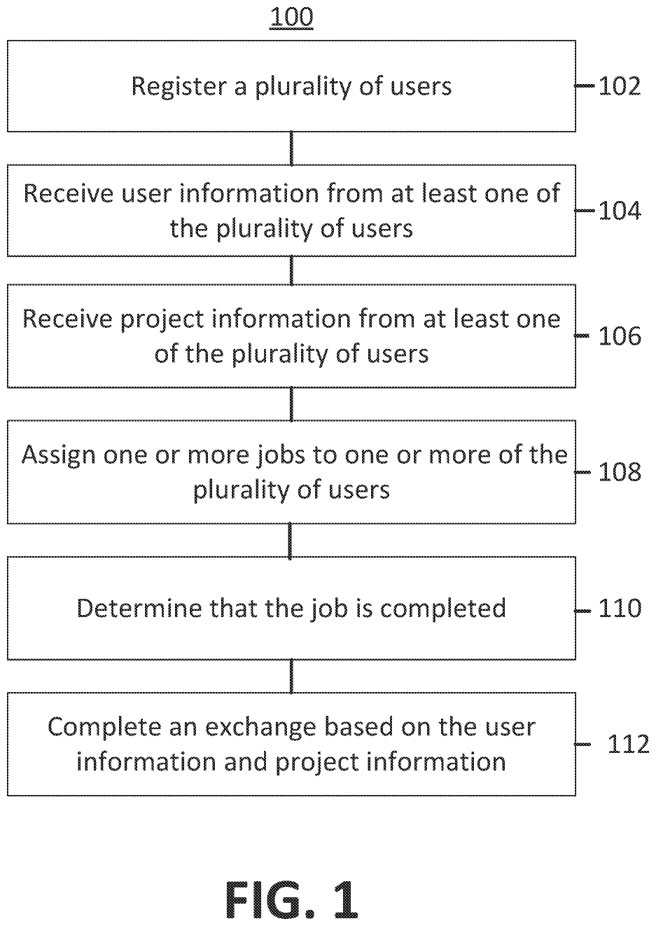

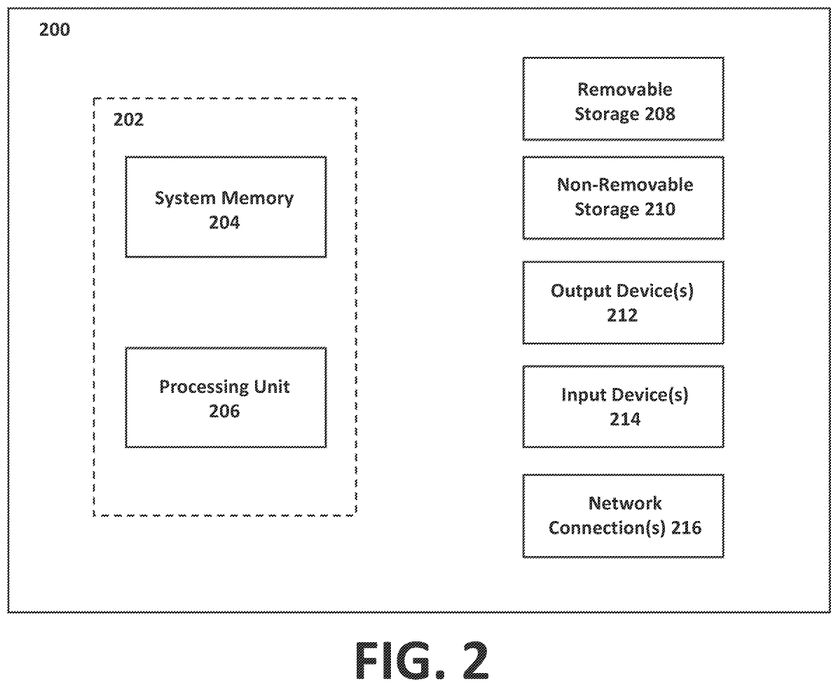

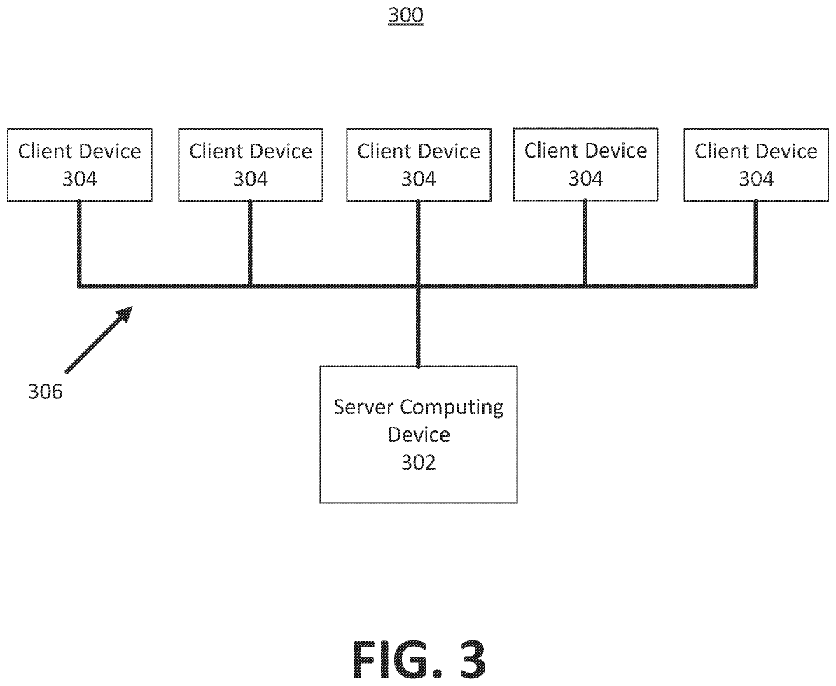

An example implementation is shown in FIG. 3. FIG. 3 shows a system 300 including any number of server computing device 302 and any number of client devices 304. The server computing device 302 and client devices 304 can be dispersed over any geographic area. The server computing device 302 and the client devices 304 can be connected by a network 306. The network 306 can include any combination of wired and/or wireless communication (as described with reference to the computing device 200 show in FIG. 2). It should also be understood that the client device 304 and server computing device 302 can also include any/all of the elements described with respect to the computing device 200. The client devices 304 can be configured to acquire information (e.g., project information and/or user information) from any number of users, or from any number of projects. The server 302 can further be configured to implement methods for project management (e.g., the method 100 shown in FIG. 1).

The system 300 shown in FIG. 3 can overcome deficiencies of existing project management systems and methods. By centralizing user information and project information in the server computing device 302, the server computing device 302 can efficiently match users and projects to simplify project management and increase the efficiency of project managers. Moreover, the server can implement a platform or platforms for implementing any/all project management tasks and communicate those tasks with users of the system 300 using any number of client devices 304.

The platform can solve the above problems as well as other problems associated with controlling a project (i.e. selecting and managing one or more parties to complete one or more objectives). The platform can process and distribute information for project planning and management, as well as completing associated exchanges and payments. Implementations of the present disclosure include the capabilities to provide, receive, store, host, retrieve, disseminate and facilitate the transfer of information such as transaction information, business information, pricing information and location information.

The location information can include enhanced navigation/location and mapping feature, enabling users to interface with other internal and external networks and applications. The platform can include systems for sourcing products, services and data; securing products, services and data; uploading and downloading intel/data; and receiving and distributing funds, payments and invoicing in any currency or asset (e.g., by tangible assets, intangible assets, barter and/or other exchanges of consideration). Implementations of the present disclosure include allowing one or more users to perform a vast array of tasks/features that can be operated simultaneously or as desired (by any number of users).

With reference to FIG. 1, a flowchart 100 illustrating example operations according to an implementation of the present disclosure are shown.

At step 102, the users are registered. Registration can be performed using any suitable computing device for receiving user information. As a non-limiting example, in some implementations, registration is performed using an application (“app”) on a mobile device such as a cell phone or laptop. The user or users can create an account using the app, and information from the system can be provided to the user or users through the app.

At step 104, user information is received from the plurality of users. The user information can be provided as part of registration 102 or after the user is registered. The user information can include biographical details, and information about skills (e.g., resumes or other credentials). Additionally, the user information can include information about the user's relationship to other users. For example, the user information can include information about a user's position in an organizational structure (e.g., which other users they are in charge of and who is in charge of that user). The user information can also include information about contact information. In some implementations, this information can be used to form a graph or chart of the organizational structure of one or more groups of users. Similarly, in some implementations one person can be designated a lead/head administrator for an organization, and the lead/head administrator can control the permissions/authority of other users.

Similarly, the user information can include information corresponding to the “role” of a user in an organization. The role can represent the user's job responsibilities, level of authority, and other relevant details. In some implementations, additional users, roles and access levels can be added and removed at any time. According to some implementations, only users with certain roles can add, and/or remove users or change access levels of other users. Additionally in some implementations, multiple users/individuals can have equal roles, access and authority on the platform. As a non-limiting example, multiple users can share the same level of access and responsibilities in an organization.

Throughout the present disclosure the term “administrator” is used to refer to a user or users with roles that allow them to manage or control other users. It should be understood that the present disclosure contemplates that more than one administrator can exist for a given project, and that different administrators can have different roles and/or access levels based on their user information.

At step 106, project information is received from one or more of the plurality of users. The project information can include any information that is relevant to a project. For example, the project information can include information about the project budget, project deadline, jobs required to complete the project, project management or administrators, and ownership of the project. Throughout the present disclosure, the individual pieces of data that comprise the project information are referred to as “attributes” or “project attributes.”

The project information can be viewed by one or more of the plurality of users. In some implementations, access to some or all of the project information is limited to users with specific role(s) in their organization. As a non-limiting example, the user information for the user can determine what project information the user can view. The present disclosure contemplates that any number of users can hold the same role, and that any number of users can simultaneously view the project information. Additionally, the present disclosure contemplates that any number of users can simultaneously view some or all of the user information. This can include, as a non-limiting example, each of the users simultaneously viewing the location of one or more of the other users.

In some implementations, users can edit or remove project information from the system. As a non-limiting example, in some implementations, users can change or amend the scope of a project, which can be considered part of the “project information” for that project. Again, the system can prevent a user from editing or deleting some or all of the project information based on the user information corresponding to that user. As a non-limiting example, deleting and/or editing project information can be limited to users with a minimum level of authority within the organization, based on the user information. The levels of authority or roles required to delete and/or edit and/or access information can each be different. Again, as a non-limiting example, users that can edit project information may not be able to delete project information, and users that can view project information may not be able to edit that project information. Different configurations of user permissions are contemplated by the present disclosure, and the user configurations described herein are intended only as examples.

The present disclosure also contemplates that the platform can include features that enable users to access different project and/or user information on the platform based on their obligations and/or participation in different projects. Additionally, users can share information, including project and/or user information, for example by uploading, downloading, and sharing files. Non-limiting examples of files that can be shared include documents, photos, computer aided design files, maps, and any other information that is relevant to a project (e.g., relevant to the set of jobs, activities, tasks, or sets of instructions that make up the project). The present disclosure also contemplates that users can export data in different document types or formats. Furthermore, implementations of the present disclosure can transmit information to users of the application as well as to people that are not using the application. As a non-limiting example, the system can export a file into an email application so that the file can be transmitted to a person who is not using the system. Additionally, the present disclosure contemplates that sharing files can be accomplished even when users are not actively using the app. As a non-limiting example, a user can send data (e.g., intelligence regarding a project or photos) to the application. This can be performed using any suitable method, including by text message.

It should be understood that in some implementations of the present disclosure, users can control the amount of user information visible to other users of the system. For example, a user can choose to only disclose their location information to users associated with a particular project, or only disclose their location information for a limited period of time, or to disclose their information to users who have certain roles.

The project information can include one or more jobs that are included in the project. The jobs can represent discrete activities tasks, or sets of instructions within a project, and each project can include one more jobs. As a non-limiting example, a plumbing project could include a job representing preparing the worksite, a job representing installing pipes, and a job representing cleaning up the worksite. In turn, these jobs can include all the activities or tasks required to prepare the worksite, install the pipes, and clean up the worksite. The jobs can also be associated with a level of compensation for each job, and/or a deadline for each job.

As another non-limiting example, a project for constructing a building foundation may include separate jobs for grading the earth, digging a basement, preparing footers, and pouring concrete. It is also contemplated that users of the system can define what activities are included in each job, so that different jobs can include different activities in different projects. As another non-limiting example, in one project the job of cleaning up the worksite can include the activities or tasks of gathering trash and hauling the trash away. While in another example gathering trash and hauling the trash can be represented as separate jobs. While examples have been described with three or four jobs in a project, it is contemplated by the present disclosure that a project can include any number of jobs, and that larger projects may include large numbers of jobs.

In some implementations, editing or deleting project information can require a change order process to be completed using the system. The change order process can include one user proposing a change order to another user who is part of the same project. The system can store the change order in the system, and transmit the change order to the one or more users who are affected by the change order. Transmitting the change order can be performed based on the user and/or project information stored by the system. If the change order is accepted, the change order becomes part of the project terms, and the project is modified. However, if the change order is rejected then the project information can remain the same. Additionally, in some implementations of the present disclosure, the system can include the capability to process lien releases, waivers, and/or acknowledgements of payment. As another non-limiting example, a user can complete a lien release, waiver, and/or acknowledgement of payment using the system, and the system can inform another user that the lien release, waiver, and/or acknowledgement of payment has been completed, or prompt another user for a signature when required.

As a non-limiting example, two users of the system can be a general contractor and a subcontractor. To edit or cancel the project, the subcontractor can use the system to generate a change order and submit the change order to the general contractor. The change order can include information about the change to the project such as changes in the amounts of money to be paid, changes to who will be paid, and changes to the work included in the project. Once the subcontractor completes the change order, the system can transmit the change order to the general contractor, who can propose a modification to the change order, reject the change order, or accept the change order. If the change order is accepted, then the system changes the project information and/or jobs associated with the project based on the content of the change order. If the change is not accepted, then the project information and jobs can remain the same until the change order is accepted.

At step 108, the system can assign one or more users to a project. Assigning the one or more users to the project can be performed automatically or manually, or using a combination of automatic and manual methods.

In some implementations, the assignment 108 can be performed automatically by matching the user information to the requirements of one or more jobs that are part of the project. The system can search the user information received 104 from the one or more users, and identify users whose user information indicates that they can perform one or more jobs that are part of the project. The system can then assign the user to that job in the project, and associate the user with that project.

In some implementations, the assignment can be to a selected user. The system can provide one or more users with a list of user information received 104 from the users of the system, and that user can select users to assign 108 to a project. As a non-limiting example, the system can provide the list of user information to an administrator of a project, and that administrator can manually select users to be assigned to that project.

Implementations of the present disclosure can also include location tracking. The system can track the locations of one or more user devices, and/or receive location information from the one or more user devices. The location information for one or more users can be transmitted to one or more of the user devices, and displayed. The display can include a map illustrating the relative locations of the one or more users, as well as the locations of one or more projects based on the project information.

In some implementations of the present disclosure, the location information from the one or more user devices can be used to assign 108 users to a project manually (e.g., a user can be selected to perform the assignment) or automatically. In implementations where the assignment 108 is manual, the location of the users can be provided to an administrator, allowing the administrator to consider the user location when assigning 108 jobs. In implementations where the assignment 108 is automatic, the system can include the user location as a factor in determining whether a user should be assigned 108 to a project. Furthermore, the present disclosure contemplates that the assignment 108 can be based on a combination of manual and automatic assignment 108. For example, the system can automatically select a user based on minimum qualifications established by a project administrator.

Additionally, a user can choose to filter the display to show only users with certain user information. As a non-limiting example, the filter can be configured to show users with only certain roles, certain access levels, and certain authority levels, or combinations thereof.

A user can select users on the map. As a non-limiting example, the user can select other users by using a graphical user interface on one or more user devices. The system can transmit information about the selected user to the user device for display. The displayed information can include any kind of user information. Optionally, the user interface can be configured to display user information related to the reliability or capabilities of the selected user. Non-limiting examples of this kind of user information include information about licenses, credentials, suspensions, violations, pending action, lawsuits, past performance, and reviews by other users. Additionally, the present disclosure contemplates that reviews or other user information can be imported into the system from other sources. As another non-limiting example, the present disclosure contemplates that some or all of the user information can be obtained through web sites (e.g., web sites that aggregate reviews of a product or service).

The present disclosure contemplates that the map, location and navigation features can allow users to disclose, identify and view the location of other users, interested parties, services and projects. The present disclosure also contemplates that the map, location, and navigation features can display other information about users, interested parties, customers, providers, manufacturers, vendors, and payees. Additionally, the system can allow users to search for projects based on the project information, express interest in projects, and make inquiries about projects.

Similarly, in some implementations of the present disclosure, the user can filter the map to show projects that have certain project attributes or combinations of project attributes. For example, the user can configure the display to show projects that include certain jobs, or are within a certain region. Additionally, a user can choose to view the location and/or user information for all users associated with a particular project. As a non-limiting example, the user can configure the display to show the locations of all users with a particular role who are working on a particular project.

Implementations of the present disclosure allow a user to disclose their information to everyone and/or select individuals. Additionally the user can decide whether to provide the information for a limited period of time, or for an indefinite period of time. The system can use the location information to determine whether a job is complete, or the amount of progress on the job, by measuring the amount of time that the user is in the location where the job is, and assuming that the user is performing work at a certain rate. Determining the amount of progress on the job can be referred to as “monitoring” the progress on the job or “determining the state of the job.” The “state” of the job can refer to how much progress has been made on the job, or how close the job is to being complete. In some implementations, the system can determine the amount of progress on the job by receiving additional user and/or project information. As a non-limiting example, the system can receive additional user and/or project information over a period of time, and the system can use that information to monitor the amount of progress made on the project. Optionally, the system can release installment payments, prepare to release installment payments, determine there is a delay, and/or determine that a project is complete based on the location information.

In some implementations, the assignment 108 can include information about a response to a request (e.g., a bid offering to provide services and/or material at a price), or an opportunity to respond to a request As a non-limiting example, the user interface of the system can be configured to allow a user to place a bid on a project. The bid can represent an offer to provide services, labor or goods to the project at a specified price. The bid can be transmitted by the system to a user associated with the project (e.g., a person with a leadership role) and user associated with the project can use the system to accept or reject the bid. Again, a bid is intended only as a non-limiting example. As described throughout the present disclosure, the users associated with the project can use the system to perform any of the operations described herein.

Similarly, implementations of the present disclosure allow a user to express interest in a particular project, or communicate with users associated with a particular project. Again, implementations of the present disclosure can base the assignment 108 in part on whether a user has expressed interest in a project or communicated about the project. A non-limiting example of a device for location tracking that can be used in embodiments of the present disclosure is a GPS receiver.

Optionally, in some implementations the system can transmit a notification to one or more users. This notification can be based on the user information and project information. As a non-limiting example, the notification can be limited to users that are associated with a particular project, and have a particular role. Another non-limiting example of a notification is a notification that a change order or change request has been placed, that a payment has been made, or that a job has been assigned to the user. As yet another non-limiting example, the present disclosure contemplates that transmitting the notification can include transmitting the user and/or project information to all users, or to users that are in a particular predetermined group. The present disclosure also contemplates that the user information can be transmitted to a website, where the information can be viewed by the public.

Again, the system can disable import, export, and sharing features for users without the correct user information (e.g., incorrect role or authority levels), according to some implementations of the present disclosure. Furthermore, the present disclosure contemplates that, based on a user's user information, the system can allow or forbid any of the application features.

In some implementations, the system can issue notifications including progress reports/alerts to all or part of the group on a macro or micro level. Similarly, the system can issue notifications to a whole group of users, or only some users in the group.

At step 110 the system determines the state of the job, which can include determining whether the job is completed. As a non-limiting example, the system can determine that a job is completed based on a user (e.g., an administrator) marking the job as completed in a user interface. Additionally, the system can determine that a job has been completed based on the user information (e.g., user location) and/or the project information (e.g., job deadlines or other project attributes). As a non-limiting example, at step 110 the system can determine that the job is completed, delayed, or ceased based on the location of the users associated with the project.

At step 112, an exchange can be performed based on the status of the project and/or jobs within that project. The exchange 112 can be based on determining 110 whether a job has been completed. The exchange 112 can be defined in the user information and/or project information, and when the job and/or project is completed it can trigger an exchange 112 with one or more of the users associated with the job/project.

As a non-limiting example, the project information can specify a project scope that includes the type of exchange 112, and the exchange 112 can be an exchange of money. The exchange 112 can include a sum certain on a particular date. Alternatively, or additionally, the exchange can include a sum certain after a certain obligation is completed, and the obligation can be an inspection or approval.

Similarly, the system can receive and distribute funds/payment to all designated recipients accordingly by transferring/rerouting funds to an external account, financial institutions, mail or any other suitable method of exchange.

The present disclosure contemplates that the system can enable the management, receipt and distribution of all forms of consideration. Non-limiting examples of forms of consideration include funds and funding including but not limited to tangible and intangible currency (e.g., cash, money and digital currencies), assets and exchanges of any other type of value (e.g., barter). Management and receipt of consideration can include managing distributions and withdrawals from internal accounts, external accounts, financial institutions, paymasters etc. to host and manage funds.

In some implementations, the currency or other exchange of value can be retained, hosted and managed under an escrow account or as established by user and released accordingly in whole, part, installments or as desired or dictated by user. This process can include releasing and making progress payments automatically based on the project and/or user information or manually based on user input. Similarly, the present disclosure contemplates that currency/funds can be received or distributed to one or several users or interested parties simultaneously or as desired by users.

Additionally, implementations can convert currencies or other exchanges of value to the user desired currency based on the user information or settings selected by the user. Optionally users can determine the accounting method for/of available funds/account information on the platform by selecting desired unit (from the preselected menu options) as currency, barter value and physical unit measurement formula. A physical unit measurement formula can represent a conversion between different measurements used by the system. As a non-limiting example, the system can use square feet to measure an area, and the system can use physical unit measurement formulas to convert from square feet to any other suitable unit (e.g., acres or square inches). Additionally, the system can perform calculations using the project information and physical unit measurement formulas. As another non-limiting example, if the project information includes a floorplan, the system can convert from the dimensions (e.g., feet) of that floorplan to an area (square feet) of the floorplan. It should be understood that different users of the system can choose to display the user and/or project information (including currency exchange rates) using different units, and that the system can perform the conversions automatically.

As another non-limiting example of a conversion that can be performed by the system, in some implementations, the system can perform accounting and conversions within related accounts to provide a user with an accounting of funds in respective accounts. A user can select, using a user interface, currency exchange rates or values, and the system can automatically populate currency exchange rates/values based on the user selection. Additionally, the present disclosure contemplates that users can be notified currency exchanges between all users/interested parties to ensure uniformity and accuracy between each transaction.

The present disclosure contemplates that the systems disclosed herein can be implemented on any suitable computing environment. As a non-limiting example, the system can be implemented on one or more servers (commonly referred to as “the cloud”) and the one or more servers can store the user information and/or project information. Additionally, the present disclosure contemplates that aspects of the system can incorporate artificial intelligence or machine learning techniques. As a non-limiting example, machine learning techniques can be used to predict whether a user has the correct qualifications for a job, or to predict whether a job has been completed.

It should be appreciated that the logical operations described herein with respect to the various figures may be implemented (1) as a sequence of computer implemented acts or program modules (i.e., software) running on a computing device (e.g., the computing device described in FIG. 2), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 2, an example computing device 200 upon which the methods described herein may be implemented is illustrated. It should be understood that the example computing device 200 is only one example of a suitable computing environment upon which the methods described herein may be implemented. Optionally, the computing device 200 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 200 typically includes at least one processing unit 206 and system memory 204. Depending on the exact configuration and type of computing device, system memory 204 may be volatile (such as random access memory (RAM)), non-volatile (such as read-only memory (ROM), flash memory, etc.), or some combination of the two. This most basic configuration is illustrated in FIG. 2 by dashed line 202. The processing unit 206 may be a standard programmable processor that performs arithmetic and logic operations necessary for operation of the computing device 200. The computing device 200 may also include a bus or other communication mechanism for communicating information among various components of the computing device 200.

Computing device 200 may have additional features/functionality. For example, computing device 200 may include additional storage such as removable storage 208 and non-removable storage 210 including, but not limited to, magnetic or optical disks or tapes. Computing device 200 may also contain network connection(s) 716 that allow the device to communicate with other devices. Computing device 200 may also have input device(s) 214 such as a keyboard, mouse, touch screen, etc. Output device(s) 212 such as a display, speakers, printer, etc. may also be included. The additional devices may be connected to the bus in order to facilitate communication of data among the components of the computing device 200. All these devices are well known in the art and need not be discussed at length here.

The processing unit 206 may be configured to execute program code encoded in tangible, computer-readable media. Tangible, computer-readable media refers to any media that is capable of providing data that causes the computing device 200 (i.e., a machine) to operate in a particular fashion. Various computer-readable media may be utilized to provide instructions to the processing unit 206 for execution. Example tangible, computer-readable media may include, but is not limited to, volatile media, non-volatile media, removable media and non-removable media implemented in any method or technology for storage of information such as computer readable instructions, data structures, program modules or other data. System memory 204, removable storage 208, and non-removable storage 210 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 206 may execute program code stored in the system memory 204. For example, the bus may carry data to the system memory 204, from which the processing unit 206 receives and executes instructions. The data received by the system memory 204 may optionally be stored on the removable storage 208 or the non-removable storage 210 before or after execution by the processing unit 206.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system, comprising:
a processor; and
a memory operably coupled to the processor, wherein the memory has computer-executable instructions stored thereon that, when executed by the processor, cause the processor to:
register a plurality of users;
receive user information from at least one of the plurality of users;
receive project information from at least one of the plurality of users, wherein the project information represents a project, and wherein the project information includes information representing a plurality of jobs associated with the project information;
assign a job from the plurality of jobs to one of the plurality of users;
determine a state of the job; and
initiate an exchange based on the project information and the user information.

2. The system of claim 1, wherein the user information comprises location information.

3. The system of claim 1, wherein the user information comprises location information, and determining whether the job is completed is based at least partially on the location information.

4. The system of claim 1, wherein determining the state of the job comprises determining that the job is completed.

5. A system, comprising:
a plurality of client devices, each client device being associated with a respective user of a plurality of users; and
a server computing device operably coupled to the client devices via a network, wherein the server computing device comprises a processor and a memory operably coupled to the processor, wherein the memory has computer-executable instructions stored thereon that, when executed by the processor, cause the server computing device to:
receive user information from at least one of the plurality of client devices;
receive project information from at least one of the plurality of client devices, wherein the project information represents a project, and wherein the project information includes information representing a plurality of jobs associated with the project information;
assign a job from the plurality of jobs to one of the plurality of users;
determine a state of the job; and
complete an exchange based on the project information and the user information.

6. The system of claim 5, wherein the user information comprises location information.

7. The system of claim 5, wherein the user information comprises location information, and determining whether the job is completed is based at least partially on the location information.

8. The system of claim 5, wherein determining the state of the job comprises determining that the job is completed.

9. A computer implemented method, comprising:
registering a plurality of users;
receiving user information from at least one of the plurality of users;
receiving project information from at least one of the plurality of users;
assigning one or more jobs to one or more of the plurality of users based on the user information and project information;
determining a state of the job; and
completing an exchange based on the user information and the project information.

10. The computer implemented of claim 9, wherein the user information comprises location information.

11. The computer implemented of claim 9, wherein the user information comprises location information, and determining whether the job is completed is based at least partially on the location information.

12. The computer implemented of claim 9, wherein determining the state of the job comprises determining that the job is completed.
